(19) United States
(12) Patent Application Publication
(10) Pub. No.: US 2022/0064483 A1
(43) Pub. Date: Mar. 3, 2022

(54) SURFACE COATING COMPOSITIONS

(71) Applicant: Merck Patent GmbH, Darmstadt (DE)

(72) Inventors: Ralf GROTTENMUELLER, Weiterstadt (DE); Sergej NELL, Heppenheim (DE); Susanne WEIDEMANN, Modautal (DE); Masahiro TANIDA, Kanagawa (JP)

(73) Assignee: Merck Patent GmbH, Darmstadt (DE)

(21) Appl. No.: 17/313,000

(22) PCT Filed: Oct. 31, 2019
(86) PCT No.: PCT/EP2019/079760

§ 371 Date: Jun. 11, 2021

(30) Foreign Application Priority Data
Dec. 14, 2018 (EP) 18212748.0

(51) Int. Cl. C09D 183/16; C09D 183/04; C09D 127/14; C09D 129/10; C08G 77/62

(52) U.S. Cl. CPC C09D 183/16; C09D 183/04; C08G 77/62; C09D 129/10; C09D 127/14

(57) ABSTRACT

The present invention relates to new coating compositions for the preparation of functional surface coatings on various base material substrates. The coating compositions are based on a silazane-containing polymer and a fluorine-containing polymer, wherein the fluorine-containing polymer comprises a first repeating unit U¹ and a second repeating unit U². The coating compositions provide improved physical and chemical surface properties and may be applied by user-friendly methods.

### TECHNICAL FIELD

The present invention relates to new coating compositions which are based on a silazane-containing polymer and a fluorine-containing polymer. The coating compositions are particularly suitable for the preparation of functional coatings on various base material substrates to provide improved physical and chemical surface properties such as, in particular, improved mechanical resistance and durability (including improved surface hardness, improved scratch resistance and/or improved abrasion resistance); improved wetting and adhesion properties (including hydro- and oleophobicity, easy-to-clean effect and/or anti-graffiti effect); improved chemical resistance (including improved corrosion resistance (e.g. against solvents, acidic and alkaline media and corrosive gases) and/or improved anti-oxidation effect); improved optical effects (improved light fastness); and improved physical barrier or sealing effects.

Beyond that, further beneficial surface properties may be obtained or may be improved by functional coatings which are based on the coating composition according to the present invention such as, e.g. antistatic effect, anti-staining effect, anti-fingerprint effect, anti-fouling effect, smoothening effect, and/or optical effects.

Furthermore, the coating compositions show high adhesion to various substrate surfaces and they allow an easy application by user-friendly methods so that functional surface coatings with various film thicknesses may be obtained in an efficient and easy manner under mild conditions.

The present invention further relates to a method for preparing a coated article using said coating composition and to a coated article which is prepared by said method. There is further provided for the use of said composition for forming a functional coating on the surface of a base material, thereby improving one or more of the above-mentioned specific surface properties.

### BACKGROUND OF THE INVENTION

Polymers which contain a silazane repeating unit —[SiR₂—NR′-] are typically referred to as polysilazanes. If all substituents R and R′ are hydrogen, the material is called perhydropolysilazane (PHPS) and, if at least one of R and R′ is an organic moiety, the material is called organopolysilazane (OPSZ). PHPS and OPSZ are used for a variety of functional coatings to impart certain properties to surfaces, such as e.g. anti-graffiti effect, scratch resistance, corrosion resistance or hydro- and oleophobicity. Hence, silazanes are widely used for functional coatings for various applications.

While polysilazanes are composed of one or more different silazane repeating units, polysiloxazanes additionally contain one or more different siloxane repeating units. Polysiloxazanes combine features of polysilazane and polysiloxane chemistry and behavior. Polysilazanes and polysiloxazanes are resins that are used for the preparation of functional coatings for different types of application.

Typically, both polysilazanes and polysiloxazanes are liquid polymers which become solid at molecular weights of ca.>10,000 g/mol. In most applications, liquid polymers of moderate molecular weights, typically in the range from 2,000 to 8,000 g/mol, are used. For preparing solid coatings from such liquid polymers, a curing step is required which is carried out after applying the material on a substrate, either as a pure material or as a formulation.

Polysilazanes or polysiloxazanes can be crosslinked by hydrolysis, wherein moisture from the air reacts according to the mechanisms as shown by Equations (1) and (II) below:

### Equation (1): Hydrolysis of Si—N Bond

R₃Si—NH—SiR₃+H₂O→R₃Si—O-SiR₃+NH₃

### Equation (II): Hydrolysis of Si—H Bond

R₃Si-H+H-SiR₃+H₂O→R₃Si—O—SiR₃+2H₂

During hydrolysis the polymers crosslink and the increasing molecular weight leads to a solidification of the material. Hence, the crosslinking reactions lead to a curing of the polysilazane or polysiloxazane material. For this reason, in the present application the terms “curing” and “crosslinking” and the corresponding verbs “cure” and “crosslink” are interchangeably used as synonyms when referred to silazane based polymers such as e.g. polysilazanes and polysiloxazanes. Usually, curing is performed by hydrolysis at ambient conditions or at elevated temperatures.

There is a strong need to find novel materials systems which allow the preparation of improved functional coatings that meet the increasingly demanding requirements in industry. Thus, various hybrid systems have been proposed which involve polysilazanes with some fluorine modifications or fluorinated additives.

P. Furtat et al. describes in J. Mater. Chem. A, 2017, 5, 25509-25521 the synthesis of fluorine-modified polysilazanes via Si—H bond activation and their application as protective hydrophobic coatings. The scientific paper relates to OPSZ with fluorinated silicon alkoxide side chains: —Si—O—CH₂CF₃. The disadvantage of such systems is the instability of such groups towards hydrolysis.

CN 107022269 A describes a self-cleaning, superhard and hydrophobic formulation based on a polyacrylate, SiO₂ nanoparticles and a fluorinated OPSZ which may have Si—CF₃, Si—CH₂—CF₃, Si—CH₂—CH₂—CF₃ or Si—CH₂CH₂COOCH₂CF₃ groups. A disadvantage is the short fluorinated side chain and the random distribution of fluorinated groups “diluted” by fluorine-free silazane repeating units, which makes it impossible to achieve a fully fluorinated surface.

U.S. Pat. No. 9,994,732 B1 relates to mixtures of OPSZ and fluorinated acrylic polymers. Due to the incompatibility of both polymers, a demixing and formation of turbid films may occur during processing and curing, especially in case fluoro acrylates with high molecular weight are used. If fluoro acrylates with low molecular weight are used, the repellent effects of the obtained coatings are poor. To avoid macroscopic phase separation, the maximum amount of fluoro acrylate is limited to a small percentage only.

US 2012/0264962 A1 describes silazane compounds having two fluoroalkyl groups which are obtained from specific chlorosilane monomers having double chain fluorinated silicon sidechains. Disadvantages are the multi-step synthesis of the monomer and the fact that the fluorinated groups are randomly distributed within the polymer so that the fluorinated parts are “diluted” by fluorine-free silazane repeating units, which makes it impossible to achieve a fully fluorinated surface.

US 2006/0246221 A1 relates to a process for coating a surface with fluorosilanes or fluorosilane containing condensates, wherein a) in a first step a polysilazane solution is disposed on said surface which comprises a polysilazane, a solvent and a catalyst; and b) in a second step fluorosilanes or fluorosilane containing condensates are disposed on said surface to provide a coated surface.

US 2007/0149714 A1 relates to a composition comprising a fluorocarbon polymer, a radical initiator, and a first curing co-agent. The first curing co-agent comprises at least one silicon-containing group selected from a hydrocarbyl silane and a hydrocarbyl silazane. Furthermore, the first curing co-agent is substantially free of siloxane groups and comprises at least one polymerizable ethylenically unsaturated group. However, the composition described in US 2007/0149714 A1 may only be applied by press curing and is not suitable for application methods from solution, such as e.g. spray coating, which severely restricts its application possibilities, in particular, if surface application is desired.

WO 2011/002668 A1 relates to methods of treating substrates to impart water, oil, stain, and/or dirt repellency to a surface thereof. In particular, a surface treatment process is described, which comprises (a) providing at least one substrate having at least one major surface; (b) combining (1) at least one curable oligomeric or polymeric polysilazane comprising at least one chemically reactive site, and (2) at least one fluorochemical compound comprising (i) at least one organofluorine or heteroorganofluorine moiety that comprises at least about six perfluorinated atoms, and (ii) at least one functional group that is capable of reacting with the polysilazane through the at least one of the chemically reactive sties; (c) allowing or inducing the polysilazane and the fluorochemical compound to react to form at least one curable organofluorine-modified polysilazane; (d) applying the curable organofluorine-modified polysilazane or its precursors to at least a portion of at least one major surface of the substrate; and (e) curing the curable organofluorine-modified polysilazane to form a surface treatment

Disadvantages of the described methods are the liquid physical appearance of the fluorochemical compound as well as a reduced hardness and scratch resistance, if high amounts of the fluorochemical compound are used.

### Object of the Invention

It is an aim of the present invention to overcome the disadvantages in the prior art and to provide new coating compositions which are particularly suitable for the preparation of functional surface coatings on various base materials to provide improved physical and chemical surface properties such as, in particular, improved mechanical resistance and durability (including improved surface hardness, improved scratch resistance and/or improved abrasion resistance); improved wetting and adhesion properties (including hydro- and oleophobicity, easy-to-clean effect and/or anti-graffiti effect); improved chemical resistance (including improved corrosion resistance (e.g. against solvents, acidic and alkaline media and corrosive gases) and/or improved anti-oxidation effect); improved optical effects (improved light fastness); and improved physical barrier or sealing effects.

Beyond that, it is desirable to obtain or improve further beneficial surface properties such as, e.g. antistatic effect, anti-staining effect, anti-fingerprint effect, anti-fouling effect, smoothening effect, and/or optical effects.

Moreover, it is an object of the present invention to provide new coating compositions which, in addition to the above-mentioned advantages, show high adhesion to various substrate surfaces and allow an easy application by user-friendly methods so that functional surface coatings with high film thickness are obtained in an efficient and easy manner under mild conditions.

It is a further object of the present invention to provide a method for preparing coated articles and coated articles which are prepared by said method having the above-mentioned advantages.

Finally, it is an object of the present invention to provide a coating composition which can be used for forming functional coatings on the surface of various base materials in order to improve one or more of the above-mentioned surface properties, specifically corrosion resistance, for example against solvents, acidic and alkaline media and corrosive gases; surface hardness; and scratch resistance.

### SUMMARY OF THE INVENTION

The present inventors have surprisingly found that the above objects are solved either individually or in any combination by a coating composition, comprising:
(i) a silazane-containing polymer; and
(ii) a fluorine-containing polymer comprising a first repeating unit U¹ and a second repeating unit U²;
   characterized in that the first repeating unit U¹ is a fluorine-containing ethylene repeating unit and the second repeating unit U² is a fluorine-free vinyl ether repeating unit.

In addition, a method for preparing a coated article is provided, wherein the method comprises the following steps:
(a) applying a coating composition according to the present invention to a surface of an article; and
(b) curing said coating composition to obtain a coated article.

Moreover, a coated article is provided, which is obtainable or obtained by the above-mentioned preparation method.

The present invention further relates to the use of the coating composition according to the present invention for forming a functional coating on the surface of a base material.

Preferred embodiments of the invention are described in the dependent claims.

### DETAILED DESCRIPTION

### Definitions

The term “polymer” includes, but is not limited to, homopolymers, copolymers, for example, block, random, and alternating copolymers, terpolymers, quaterpolymers, etc., and blends and modifications thereof. Furthermore, unless otherwise specifically limited, the term “polymer” shall include all possible configurational isomers of the material. These configurations include, but are not limited to isotactic, syndiotactic, and atactic symmetries. A polymer is a molecule of high relative molecular mass, the structure of which essentially comprises the multiple repetition of units (i.e. repeating units) derived, actually or conceptually, from molecules of low relative mass (i.e. monomers). Typically, the number of repeating units is higher than 10, preferably higher than 20, in polymers. If the number of repeating units is less than 10, the polymers may also be referred to as oligomers.

The term “monomer” as used herein, refers to a molecule which can undergo polymerization thereby contributing constitutional units (repeating units) to the essential structure of a polymer.

The term “homopolymer” as used herein, stands for a polymer derived from one species of (real, implicit or hypothetical) monomer.

The term “copolymer” as used herein, generally means any polymer derived from more than one species of monomer, wherein the polymer contains more than one species of corresponding repeating unit. In one embodiment the copolymer is the reaction product of two or more species of monomer and thus comprises two or more species of corresponding repeating unit. It is preferred that the copolymer comprises two, three, four, five or six species of repeating unit. Copolymers that are obtained by copolymerization of three monomer species can also be referred to as terpolymers. Copolymers that are obtained by copolymerization of four monomer species can also be referred to as quaterpolymers. Copolymers may be present as block, random, and/or alternating copolymers.

The term “block copolymer” as used herein, stands for a copolymer, wherein adjacent blocks are constitutionally different, i.e. adjacent blocks comprise repeating units derived from different species of monomer or from the same species of monomer but with a different composition or sequence distribution of repeating units.

Further, the term “random copolymer” as used herein, refers to a polymer formed of macromolecules in which the probability of finding a given repeating unit at any given site in the chain is independent of the nature of the adjacent repeating units. Usually, in a random copolymer, the sequence distribution of repeating units follows Bernoullian statistics.

The term “alternating copolymer” as used herein, stands for a copolymer consisting of macromolecules comprising two species of repeating units in alternating sequence.

The term “polysilazane” as used herein, refers to a polymer in which silicon and nitrogen atoms alternate to form the basic backbone. Since each silicon atom is bound to at least one nitrogen atom and each nitrogen atom to at least one silicon atom, both chains and rings of the general formula —[SiR¹R²—NR³-]ₘ (silazane repeating unit) occur, wherein R¹ to R³ may be hydrogen atoms, organic substituents or heteroorganic substituents; and m is an integer. If all substituents R¹ to R³ are hydrogen atoms, the polymer is designated as perhydropolysilazane, polyperhydrosilazane or inorganic polysilazane (—[SiH₂—NH-]ₘ). If at least one substituent R¹ to R³ is an organic or heteroorganic substituent, the polymer is designated as organopolysilazane.

The term “polysiloxazane” as used herein, refers to a polysilazane which additionally contains sections in which silicon and oxygen atoms alternate. Such sections may be represented, for example, by —[O—SiR⁷R⁸-]ₙ, wherein R⁷ and R⁸ may be hydrogen atoms, organic substituents, or heteroorganic substituents; and n is an integer. If all substituents of the polymer are hydrogen atoms, the polymer is designated as perhydropolysiloxazane. If at least one substituents of the polymer is an organic or heteroorganic substituent, the polymer is designated as organopolysiloxazane.

The term “functional coating” as used herein refers to coatings which impart one or more specific properties to a surface. Generally, coatings are needed to protect surfaces or impart specific effects to surfaces. There are various effects which may be imparted by functional coatings. For example, mechanical resistance, surface hardness, scratch resistance, abrasion resistance, anti-microbial effect, anti-fouling effect, wetting effect (towards water), hydro- and oleophobicity, smoothening effect, durability effect, antistatic effect, anti-staining effect, anti-fingerprint effect, easy-to-clean effect, anti-graffiti effect, chemical resistance, corrosion resistance, anti-oxidation effect, physical barrier effect, sealing effect, heat resistance, fire resistance, low shrinkage, UV-barrier effect, light fastness, and/or optical effects.

The term “cure” means conversion to a crosslinked polymer network (for example, through irradiation or catalysis).

The term “fluorine-containing” (for example, in reference to a chemical compound or substance class) means that one or more fluorine atoms are present. The term “non-fluorine containing” or “fluorine-free” (for example, in reference to a chemical compound or substance class) means that practically no fluorine atoms are present.

The term “fluoro-” (for example, in reference to a group or moiety, such as in the case of “fluoroalkylene” or “fluoroalkyl”) or “fluorinated” means only partially fluorinated such that there is at least one carbon-bonded hydrogen atom.

The term “perfluoro-” (for example, in the reference to a group or moiety, such as in the case of “perfluoroalkylene” or “perfluoroalkyl”) or “perfluorinated” means completely fluorinated such that, except as may be otherwise indicated, there are no carbon-bonded hydrogen atoms replaceable with fluorine.

The term “aryl” as used herein, means a mono-, bi- or tricyclic aromatic or heteroaromatic group which is optionally substituted. Heteroaromatic groups contain one or more heteroatoms (e.g. N, O, S and/or P) in the aromatic moiety.

### PREFERRED EMBODIMENTS

The present invention relates to a coating composition, comprising: (i) a silazane-containing polymer; and (ii) a fluorine-containing polymer comprising a first repeating unit U¹ and a second repeating unit U²; wherein the first repeating unit U¹ is a fluorine-containing ethylene repeating unit and the second repeating unit U² is a fluorine-free vinyl ether repeating unit.

The term “ethylene repeating unit” refers to a repeating unit which is derived from an ethylene monomer after polymerization. It is to be understood that the ethylene monomer and corresponding ethylene repeating unit may be substituted.

The term “vinyl ether repeating unit” refers to a repeating unit which is (formally) derived from a vinyl ether monomer after polymerization. Vinyl ethers are also referred to as “enol ethers” which include a C═C double bond to which an oxygen atom is bonded. Vinyl ethers or enol ethers typically have the general structure R^{I}R^{II}C═CR^{III}—OR_{IV}, where R^{I}, R^{II}, R^{III} and R^{IV} may be hydrogen, halogen, organic or heteroorganic radicals. Hence, it is to be understood that the vinyl ether monomer and corresponding vinyl ether repeating unit may be substituted.

### Fluorine-Containing Polymer

The fluorine-containing polymer comprises a first repeating unit U¹ and a second repeating unit U²; wherein the first repeating unit U¹ is a fluorine-containing ethylene repeating unit and the second repeating unit U² is a fluorine-free vinyl ether repeating unit.

It is preferred that the second repeating unit U² is represented by formula (B):

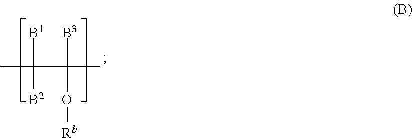

wherein B¹, B² and B³ are the same or different from each other and independently selected from hydrogen, alkyl having 1 to 30 (preferably 1 to 20, more preferably 1 to 10, most preferably 1 to 6) carbon atoms or aryl having 2 to 30 (preferably 3 to 20, more preferably 4 to 10, most preferably 6) carbon atoms; and

R^{b} is selected from an organic group, a heteroorganic group, or a combination thereof.

Suitable organic groups and heteroorganic groups for R^{b} include alkyl, alkylcarbonyl, alkenyl, cycloalkyl, aryl, arylalkyl, alkylsilyl, arylsilyl, alkoxycarbonyl, aryloxycarbonyl, and the like, and combinations thereof (preferably, alkyl, alkenyl, cycloalkyl, aryl, arylalkyl, and combinations thereof); the groups preferably having from 1 to 30 carbon atoms (more preferably, 1 to 20 carbon atoms; even more preferably, 1 to 10 carbon atoms; most preferably, 1 to 6 carbon atoms (for example, methyl, ethyl or vinyl)). The groups can be further substituted with one or more substituent groups such as halogen (fluorine, chlorine, bromine, and iodine), alkoxy, alkoxycarbonyl, amino, carboxyl, hydroxyl, nitro, sulfo, sulfonyl and the like, and combinations thereof.

Preferably, R^{b} is selected from alkyl having 1 to 30 (preferably 1 to 20, more preferably 1 to 10, most preferably 1 to 6) carbon atoms or aryl having 2 to 30 (preferably 3 to 20, more preferably 4 to 10, most preferably 6) carbon atoms.

More preferably, R^{b} is selected from hydrogen, methyl, ethyl, propyl, butyl, pentyl, hexyl or phenyl.

In a preferred embodiment, B¹, B² and B³ are the same or different from each other and independently selected from hydrogen, methyl, ethyl, propyl, butyl, pentyl, hexyl or phenyl. In a more preferred embodiment, B¹, B² and B³ are hydrogen.

It is preferred that the first repeating unit U¹ is represented by formula (A):

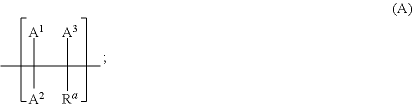

wherein A¹, A² and A³ are the same or different from each other and independently selected from F, perfluorinated alkyl having 1 to 30 (preferably 1 to 20, more preferably 1 to 10, most preferably 1 to 6) carbon atoms or prefluorinated aryl having 2 to 30 (preferably 3 to 20, more preferably 4 to 10, most preferably 6) carbon atoms; and

R^{a} is selected from F, Cl, Br or alkyl having 1 to 30 (preferably 1 to 20, more preferably 1 to 10, most preferably 1 to 6) carbon atoms or aryl having 2 to 30 (preferably 3 to 20, more preferably 4 to 10, most preferably 6) carbon atoms, wherein one or more hydrogen atoms may be replaced by F.

In a preferred embodiment, A¹, A² and A³ are the same or different from each other and independently selected from F, —CH₃, —CF₃, —CH₂CH₃, —CF₂CH₃, —CH₂CF₃, —CF₂F₃, —CH₂CH₂CH₃, —CF₂CH₂CH₃, —CH₂CF₂CH₃, —CH₂CH₂CF₃, —CF₂CF₂CH₃, —CF₂CH₂CF₃, —CH₂CF₂CF₃, —CF₂CF₂CF₃, —CH(CH₃)₂, —CF(CH₃)₂, —CH(CF₃)₂, —CF(CF₃)₂, —C₆H₅, —C₆FH₄, —C₆F₂H₃, —C₆F₃H₂, —C₆F₄H or —C₆F₅. In a more preferred embodiment, A¹, A² and A³ are F.

In a preferred embodiment, R^{a} is selected from F, Cl, Br, methyl, ethyl, propyl, butyl, pentyl, hexyl or phenyl. In a more preferred embodiment, R^{a} is selected from F or Cl.

The fluorine-containing polymer may further comprise a third repeating unit U³, wherein the third repeating unit U³ is preferably a fluorine-free repeating unit and is represented by formula (C):

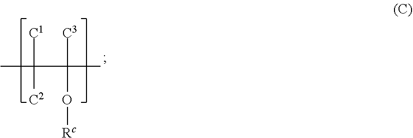

wherein C¹, C² and C³ are the same or different from each other and independently selected from hydrogen, alkyl having 1 to 30 (preferably 1 to 20, more preferably 1 to 10, most preferably 1 to 6) carbon atoms or aryl having 2 to 30 (preferably 3 to 20, more preferably 4 to 10, most preferably 6) carbon atoms; and

R^{c} is hydrogen or selected from an organic group, a heteroorganic group or a combination thereof, which comprises one or more functional groups, independently from each other selected from —OH or —Si(OR^{II})₃; wherein R^{II} is at each occurrence independently of each other alkyl having 1 to 10 (preferably 1 to 5) carbon atoms.

In a preferred embodiment, C¹, C² and C³ are the same or different from each other and independently selected from hydrogen, methyl, ethyl, propyl, butyl, pentyl, hexyl or phenyl. In a more preferred embodiment, C¹, C² and C³ are hydrogen.

In a preferred embodiment, R^{c} is hydrogen, alkyl having 1 to 30 (preferably 1 to 20, more preferably 1 to 10) carbon atoms, alkylaryl or alkylarylsulfonyl having 3 to 30 (preferably 4 to 20, more preferably 5 to 15, most preferably 7 to 12) carbon atoms, arylalkyl or arylalkylsulfonyl having 3 to 30 (preferably 4 to 20, more preferably 5 to 15, most preferably 7 to 12) carbon atoms, or alkylarylalkyl or alkylarylalkylsulfonyl having 4 to 30 (preferably 5 to 20, more preferably 6 to 15, most preferably 8 to 14) carbon atoms, wherein one or more non-terminal and non-adjacent CH₂ groups may be replaced, independently of each other, by —O—, —(C═O)—, —(C═O)O—, —O(C═O)—, —(C═O)—NR^{I}—, —NR^{I}—(C═O)—, —NR^{I}—(C═O)O—, —O(C═O)—NR^{I}—, —NR^{I}—(C═O)—NR^{I}—, —SO₂—, —C₆H₄— (phenylene), —C₁₀H₆— (naphthylene), —CH═CH— or —C≡C—, and which comprises one or more functional groups, independently of each other selected from —OH or —Si(OR^{II})₃; wherein R^{I} is hydrogen or alkyl having 1 to 10 (preferably 1 to 5) carbon atoms; and R^{II} is at each occurrence independently of each other alkyl having 1 to 10 (preferably 1 to 5) carbon atoms.

In a more preferred embodiment, R^{c} is hydrogen, alkyl having 1 to 30 (preferably 1 to 20, more preferably 1 to 10) carbon atoms, arylalkyl or arylalkylsulfonyl having 3 to 30 (preferably 4 to 20, more preferably 5 to 15, most preferably 7 to 12) carbon atoms, or alkylarylalkyl or alkylarylalkylsulfonyl having 4 to 30 (preferably 5 to 20, more preferably 6 to 15, most preferably 8 to 14) carbon atoms, wherein one or more non-terminal and non-adjacent CH₂ groups may be replaced, independently of each other, by —O—, —(C═O)—, —(C═O)—NR^{I}—, —NR^{I}—(C═O)—, —NR^{I}—(C═O)O—, —O(C═O)—NR^{I}—, —SO₂— or —C₆H₄— (phenylene), and which comprises one or more functional groups, independently of each other selected from —OH or —Si(OR^{II})₃; wherein R^{I} is hydrogen or alkyl having 1 to 10 (preferably 1 to 5) carbon atoms; and R^{II} is at each occurrence independently of each other alkyl having 1 to 10 (preferably 1 to 5) carbon atoms.

In a particularly preferred embodiment, R^{c} is selected from —H, —R^{d}—OH, —R^{d}—O—R^{e}—OH, —R^{d}—Si(OR^{II})₃, —R^{d}—O—R^{e}—Si(OR¹¹)₃ or —R^{d}—O(C═O)—NR^{I}—R^{e}—Si(OR^{II})₃, wherein R^{d} is —(CH₂)ₘ₁—, —(CH₂)ₘ₂—C₆H₄—, —SO₂—(CH₂)ₘ₂—C₆H₄—, —C₆H₄—(CH₂)ₘ₂— or —SO₂—C₆H₄—(CH₂)ₘ₂—; R^{e} is —(CH₂)ₙ₁—, —(CH₂)ₙ₂—C₆H₄— or —C₆H₄—(CH₂)ₙ₂—; R_{I} is H, methyl, ethyl, propyl, butyl or pentyl; R^{II} is at each occurrence independently of each other selected from methyl, ethyl, propyl, butyl or pentyl; m1 is an integer from 1 to 14 (preferably from 1 to 6); m2 is an integer from 1 to 12 (preferably from 1 to 5); n1 is an integer from 1 to 14 (preferably from 1 to 6); and n2 is an integer from 1 to 12 (preferably from 1 to 5).

In a most preferred embodiment, R^{c} is selected from —H, —(CH₂)ₘ₁—OH, —(CH₂)ₘ₁—Si(OR^{II})₃, —(CH₂)ₘ₂—C₆H₄—OH, —(CH₂)ₘ₂—C₆H₄—Si(OR^{II})₃, —SO₂—C₆H₄—(CH₂)ₘ₂—OH, —SO₂—C₆H₄—(CH₂)ₘ₂—Si(OR^{II})₃ or —(CH₂)ₘ₁—O(C═O)—NR^{I}—(CH₂)ₙ₁—Si(OR^{II})₃, wherein R^{I} is H, methyl, ethyl, propyl, butyl or pentyl; R^{II} is at each occurrence independently of each other selected from methyl, ethyl, propyl, butyl or pentyl; m1 is an integer from 1 to 6; m2 is an integer from 1 to 5; and n1 is an integer from 1 to 6.

It is preferred that the third repeating unit U³ is different from the second repeating unit U².

It is preferred that the molar amount of the first repeating unit U¹ in the fluorine-containing polymer is from 5 to 96%, preferably from 10 to 91%, based on the total molar amount of repeating units in the fluorine-containing polymer. The remainder accounts for the remaining repeating units in the fluorine-containing polymer including the second repeating unit U² and the optional third repeating unit U³.

It is preferred that the molar ratio of the first repeating unit U¹ and the third repeating unit U³ in the fluorine-containing polymer is in the range from 20:1 to 1:2, more preferably from 10:1 to 3:1. Such ratios result in a fluorine-containing polymer having an OH number in the range from 23 to 175, preferably 45 to 175, provided that R^{d} is H and that R^{b} is not H and does not contain any hydroxyl group.

It is preferred that the fluorine-containing polymer is soluble in fluorine-free organic solvents such as, for example, aliphatic or aromatic hydrocarbons, chlorinated hydrocarbons, esters such as ethyl acetate or butyl acetate, ketones such as acetone or methyl ethyl ketone, ethers such as tetrahydrofuran or dibutyl ether, and also mono- or polyalkylene glycol dialkyl ethers (glymes), or mixtures thereof.

In a particularly preferred embodiment of the present invention, the fluorine-containing polymer is further characterized in that it is a solid material at ambient conditions (i.e. 20 to 25° C.).

As fluorine-containing polymer, commercially available products such as, for example, Lumiflon® from AGC Chemicals may be used (see M. Unoki et al., Surface Coatings International Part B: Coatings Transactions, 2002, Vol. 5, 169-232 for further information).

Preferably, the total content of the fluorine-containing polymer in the coating composition is in the range from 10 to 90 weight-%, preferably from 20 to 80 weight-%, based on the total weight of polymers in the coating composition.

### Silazane-Containing Polymer

In a preferred embodiment, the silazane-containing polymer comprises a repeating unit M¹ which is represented by the following formula (I):

—[SiR¹R²—NR³—] (I)

wherein R¹, R² and R³ are the same or different from each other and independently selected from hydrogen, an organic group, a heteroorganic group, or a combination thereof.

Suitable organic and heteroorganic groups for R¹, R² and R³ include alkyl, alkylcarbonyl, alkenyl, cycloalkyl, aryl, arylalkyl, alkylsilyl, alkylsilyloxy, arylsilyl, arylsilyloxy, alkylamino, arylamino, alkoxy, alkoxycarbonyl, alkylcarbonyloxy, aryloxy, aryloxycarbonyl, arylcarbonyloxy, arylalkyloxy, and the like, and combinations thereof (preferably, alkyl, alkenyl, cycloalkyl, aryl, arylalkyl, alkoxy, aryloxy, arylalkyloxy, and combinations thereof); the groups preferably having from 1 to 30 carbon atoms (more preferably, 1 to 20 carbon atoms; even more preferably, 1 to 10 carbon atoms; most preferably, 1 to 6 carbon atoms (for example, methyl, ethyl or vinyl)). The groups can be further substituted with one or more substituent groups such as halogen (fluorine, chlorine, bromine, and iodine), alkoxy, alkoxycarbonyl, amino, carboxyl, hydroxyl, nitro, and the like, and combinations thereof.

In a preferred embodiment, R¹ and R² are the same or different from each other and independently selected from hydrogen, alkyl having 1 to 30 (preferably 1 to 20, more preferably 1 to 10, most preferably 1 to 6) carbon atoms, alkenyl having 2 to 30 (preferably 2 to 20, more preferably 2 to 10, most preferably 2 to 6) carbon atoms, or aryl having 2 to 30 (preferably 3 to 20, more preferably 4 to 10, most preferably 6) carbon atoms, wherein one or more hydrogen atoms bonded to carbon atoms may be replaced by fluorine; and R³ is selected from hydrogen, alkyl having 1 to 30 (preferably 1 to 20, more preferably 1 to 10, most preferably 1 to 6) carbon atoms, alkenyl having 2 to 30 (preferably 2 to 20, more preferably 2 to 10, most preferably 2 to 6) carbon atoms, or aryl having 2 to 30 (preferably 3 to 20, more preferably 4 to 10, most preferably 6) carbon atoms, wherein one or more hydrogen atoms bonded to carbon atoms may be replaced by fluorine or OR′, wherein R′ is selected from alkyl having 1 to 30 (preferably 1 to 20, more preferably 1 to 10, most preferably 1 to 6) carbon atoms.

In a more preferred embodiment, R¹ and R² are the same or different from each other and independently selected from hydrogen, methyl, ethyl, propyl, butyl, pentyl, hexyl or phenyl, wherein one or more hydrogen atoms bonded to carbon atoms may be replaced by fluorine; and R³ is selected from hydrogen, methyl, ethyl, propyl, butyl, pentyl, hexyl, vinyl or phenyl, wherein one or more hydrogen atoms bonded to carbon atoms may be replaced by —F, —OCH₃, —OCH₂CH₃, —OCH₂CH₂CH₃, or —OCH(CH₃)₂.

Most preferably, R¹, R² and R³ are the same or different from each other and independently selected from the list consisting of —H, —CH₃, —CH₂CH₃, —CH₂CH₂CH₃, —CH(CH₃)₂, —CH═CH₂, and —C₆H₅, wherein one or more hydrogen atoms bonded to carbon atoms may be replaced by fluorine.

In a preferred embodiment, the silazane-containing polymer comprises a repeating unit M² which is represented by the following formula (II):

—[SiR⁴R⁵—NR⁶—] (II)

wherein R⁴, R⁵ and R⁶ are the same or different from each other and independently selected from hydrogen, an organic group, a heteroorganic group, or a combination thereof.

Suitable organic and heteroorganic groups for R⁴, R⁵ and R⁶ include alkyl, alkylcarbonyl, alkenyl, cycloalkyl, aryl, arylalkyl, alkylsilyl, alkylsilyloxy, arylsilyl, arylsilyloxy, alkylamino, arylamino, alkoxy, alkoxycarbonyl, alkylcarbonyloxy, aryloxy, aryloxycarbonyl, arylcarbonyloxy, arylalkyloxy, and the like, and combinations thereof (preferably, alkyl, alkenyl, cycloalkyl, aryl, arylalkyl, alkoxy, aryloxy, arylalkyloxy, and combinations thereof); the groups preferably having from 1 to 30 carbon atoms (more preferably, 1 to 20 carbon atoms; even more preferably, 1 to 10 carbon atoms; most preferably, 1 to 6 carbon atoms (for example, methyl, ethyl or vinyl)). The groups can be further substituted with one or more substituent groups such as halogen (fluorine, chlorine, bromine, and iodine), alkoxy, alkoxycarbonyl, amino, carboxyl, hydroxyl, nitro, and the like, and combinations thereof.

In a preferred embodiment, R⁴ and R⁵ are the same or different from each other and independently selected from hydrogen, alkyl having 1 to 30 (preferably 1 to 20, more preferably 1 to 10, most preferably 1 to 6) carbon atoms, alkenyl having 2 to 30 (preferably 2 to 20, more preferably 2 to 10, most preferably 2 to 6) carbon atoms, or aryl having 2 to 30 (preferably 3 to 20, more preferably 4 to 10, most preferably 6) carbon atoms, wherein one or more hydrogen atoms bonded to carbon atoms may be replaced by fluorine; and R⁶ is selected from hydrogen, alkyl having 1 to 30 (preferably 1 to 20, more preferably 1 to 10, most preferably 1 to 6) carbon atoms, alkenyl having 2 to 30 (preferably 2 to 20, more preferably 2 to 10, most preferably 2 to 6) carbon atoms, or aryl having 2 to 30 (preferably 3 to 20, more preferably 4 to 10, most preferably 6) carbon atoms, wherein one or more hydrogen atoms bonded to carbon atoms may be replaced by fluorine or OR″, wherein R″ is selected from alkyl having 1 to 30 (preferably 1 to 20, more preferably 1 to 10, most preferably 1 to 6) carbon atoms.

In a more preferred embodiment, R⁴ and R⁵ are the same or different from each other and independently selected from hydrogen, methyl, ethyl, propyl, butyl, pentyl, hexyl or phenyl, wherein one or more hydrogen atoms bonded to carbon atoms may be replaced by fluorine; and R⁶ is selected from hydrogen, methyl, ethyl, propyl, butyl, pentyl, hexyl, vinyl or phenyl, wherein one or more hydrogen atoms bonded to carbon atoms may be replaced by —F, —OCH₃, —OCH₂CH₃, —OCH₂CH₂CH₃, or —OCH(CH₃)₂.

Most preferably, R⁴, R⁵ and R⁶ are the same or different from each other and independently selected from the list consisting of —H, —CH₃, —CH₂CH₃, —CH₂CH₂CH₃, —CH(CH₃)₂, —CH═CH₂, and —C₆H₅, wherein one or more hydrogen atoms bonded to carbon atoms may be replaced by fluorine.

In a preferred embodiment, the silazane-containing polymer comprises a repeating unit M³ which is represented by the following formula (III):

—[SiR⁷R⁸—O—] (III)

wherein R⁷ and R⁸ are the same or different from each other and independently selected from hydrogen, an organic group, a heteroorganic group, or a combination thereof.

Suitable organic and heteroorganic groups for R⁷ and R⁸ include alkyl, alkylcarbonyl, alkenyl, cycloalkyl, aryl, arylalkyl, alkylsilyl, alkylsilyloxy, arylsilyl, arylsilyloxy, alkylamino, arylamino, alkoxy, alkoxycarbonyl, alkylcarbonyloxy, aryloxy, aryloxycarbonyl, arylcarbonyloxy, arylalkyloxy, and the like, and combinations thereof (preferably, alkyl, alkenyl, cycloalkyl, aryl, arylalkyl, alkoxy, aryloxy, arylalkyloxy, and combinations thereof); the groups preferably having from 1 to 30 carbon atoms (more preferably, 1 to 20 carbon atoms; even more preferably, 1 to 10 carbon atoms; most preferably, 1 to 6 carbon atoms (for example, methyl, ethyl or vinyl)). The groups can be further substituted with one or more substituent groups such as halogen (fluorine, chlorine, bromine, and iodine), alkoxy, alkoxycarbonyl, amino, carboxyl, hydroxyl, nitro, and the like, and combinations thereof.

In a preferred embodiment, R⁷ and R⁸ are the same or different from each other and independently selected from hydrogen, alkyl having 1 to 30 (preferably 1 to 20, more preferably 1 to 10, most preferably 1 to 6) carbon atoms, alkenyl having 2 to 30 (preferably 2 to 20, more preferably 2 to 10, most preferably 2 to 6) carbon atoms, or aryl having 2 to 30 (preferably 3 to 20, more preferably 4 to 10, most preferably 6) carbon atoms, wherein one or more hydrogen atoms bonded to carbon atoms may be replaced by fluorine.

In a more preferred embodiment, R⁷ and R⁸ are the same or different from each other and independently selected from hydrogen, methyl, ethyl, propyl, butyl, pentyl, hexyl or phenyl, wherein one or more hydrogen atoms bonded to carbon atoms may be replaced by fluorine.

Most preferably, R⁷ and R⁸ are the same or different from each other and independently selected from the list consisting of —H, —CH₃, —CH₂CH₃, —CH₂CH₂CH₃, —CH(CH₃)₂, —CH═CH₂, and —C₆H₅, wherein one or more hydrogen atoms bonded to carbon atoms may be replaced by fluorine.

It is preferred that the silazane-containing polymer comprises a repeating unit M¹ and a further repeating unit M², wherein M¹ and M² are silazane repeating units which are different from each other.

It is also preferred that the silazane-containing polymer comprises a repeating unit M¹ and a further repeating unit M³, wherein M¹ is a silazane repeating unit and M³ is a siloxane repeating unit.

It is also preferred that the silazane-containing polymer comprises a repeating unit M¹, a further repeating unit M² and a further repeating unit M³, wherein M¹ and M² are silazane repeating units which are different from each other and M³ is a siloxane repeating unit.

In one embodiment, the silazane-containing polymer is a polysilazane which may be a perhydropolysilazane or an organopolysilazane. Preferably, the polysilazane contains a repeating unit M¹ and optionally a further repeating unit M², wherein M¹ and M² are silazane repeating units which are different from each other.

In an alternative embodiment, the silazane-containing polymer is a polysiloxazane which may be a perhydropolysiloxazane or an organopolysiloxazane. Preferably, the polysiloxazane contains a repeating unit M¹ and a further repeating unit M³, wherein M¹ is a silazane repeating unit and M³ is a siloxane repeating unit. Preferably, the polysiloxazane contains a repeating unit M¹, a further repeating unit M² and a further repeating unit M³, wherein M¹ and M² are silazane repeating units which are different from each other and M³ is a siloxane repeating unit.

Preferably, the silazane-containing polymer is a copolymer such as a random copolymer or a block copolymer or a copolymer containing at least one random sequence section and at least one block sequence section. More preferably, the silazane-containing polymer is a random copolymer or a block copolymer.

Preferably, the silazane-containing polymers used in the present invention have a molecular weight MW, as determined by GPC, of at least 1,000 g/mol, more preferably of at least 1,200 g/mol, even more preferably of at least 1,500 g/mol. Preferably, the molecular weight MW of the silazane-containing polymers is less than 100,000 g/mol. More preferably, the molecular weight MW of the silazane-containing polymers is in the range from 1,500 to 50,000 g/mol.

Preferably, the total content of the silazane-containing polymer in the coating composition is in the range from 10 to 90 weight-%, preferably from 20 to 80 weight-%, based on the total weight of the coating composition.

### Further Components

It is preferred that the coating composition according to the present invention comprises one or more solvents. Suitable solvents are fluorine-free organic solvents such as, for example, aliphatic or aromatic hydrocarbons, chlorinated hydrocarbons, esters such as ethyl acetate or butyl acetate, ketones such as acetone or methyl ethyl ketone, ethers such as tetrahydrofuran or dibutyl ether, and also mono- or polyalkylene glycol dialkyl ethers (glymes), or mixtures thereof.

Moreover, the coating composition according to the present invention may comprise one or more additives, preferably selected from the list consisting of additives influencing evaporation behavior, additives influencing film formation, adhesion promoters, anti-corrosion additives, cross-linking agents, dispersants, fillers, functional pigments (e.g. for providing functional effects such as electric or thermal conductivity, magnetic properties, etc.), nanoparticles, optical pigments (e.g. for providing optical effects such as color, refractive index, pearlescent effect, etc.), particles reducing thermal expansion, primers, rheological modifiers (e.g. thickeners), surfactants (e.g. wetting and leveling agents or additives for improving hydro- or oleophobicity and anti-graffiti effects), and viscosity modifiers.

Nanoparticles may be selected from nitrides, titanates, diamond, oxides, sulfides, sulfites, sulfates, silicates and carbides which may be optionally surface-modified with a capping agent. Preferably, nanoparticles are materials having a particle diameter of <100 nm, more preferably <80 nm, even more preferably <60 nm, even more preferably <40 nm, and most more preferably <20 nm. The particle diameter may be determined by any standard method known to the skilled person.

It is preferred that the mass ratio between the silazane-containing polymer and the fluorine-containing polymer in the coating composition of the present invention is in the range from 1:100 to 100:1, preferably from 1:50 to 50:1, more preferably from 1:10 to 10:1, even more preferably from 1:5 to 5:1, and most preferably from 1:4 to 4:1.

It is to be understood that the skilled person can freely combine the above-mentioned preferred, more preferred, particularly preferred and most preferred embodiments relating to the coating composition and definitions of its components in any desired way.

### Method

The present invention further relates to a method for preparing a coated article, wherein the method comprises the following steps:
(a) applying a coating composition according to the present invention to a surface of an article; and
(b) curing said coating composition to obtain a coated article.

In a preferred embodiment, the coating composition, which is applied in step (a), is previously provided by mixing a first component comprising a silazane-containing polymer with a second component comprising a fluorine-containing polymer, wherein the silazane-containing polymer and the fluorine-containing polymer are defined as indicated above for the coating composition. Such prior mixing is particularly suitable in case the coating composition is delivered as a two-component system.

It is preferred that the coating composition is applied in step (a) by an application method suitable for applying liquid compositions to a surface of an article. Such methods include, for example, wiping with a cloth, wiping with a sponge, dip coating, spray coating, flow coating, roller coating, slot coating, spin coating, dispensing, screen printing, stencil printing or ink-jet printing. Dip coating and spray coating are particularly preferred.

The coating composition of the invention may be applied to the surface of various articles such as, for example, buildings, dentures, furnishings, furniture, sanitary equipment (toilets, sinks, bathtubs, etc.), signs, signboard, plastic products, glass products, ceramics products, metal products, wood products and vehicles (road vehicles, rail vehicles, watercrafts and aircrafts). It is preferred that the surface of the article is made of any one of the base materials as described for the use below.

Typically, the coating composition is applied in step (a) as a layer in a thickness of 1 μm to 1 cm, preferably 10 μm to 1 mm, to the surface of the article. In a preferred embodiment, the coating composition is applied as a thin layer having a thickness of 1 to 200 μm, more preferably 5 to 150 μm and most preferably 10 to 100 μm. In an alternative preferred embodiment, the coating composition is applied as a thick layer having a thickness of 200 μm to 1 cm, more preferably 200 μm to 5 mm and most preferably 200 μm to 1 mm.

The curing of the coating in step (b) may be carried out under various conditions such as e.g. by ambient curing, thermal curing and/or irradiation curing. The curing is optionally carried out in the presence of moisture, preferably in the form of water vapor.

Ambient curing preferably takes place at temperatures in the range from 10 to 30° C., preferably from 20 to 25° C. Thermal curing preferably takes place at temperatures in the range from 100 to 200° C., preferably from 120 to 180° C.

Preferably, the curing in step (b) is carried out in a furnace or climate chamber. Alternatively, if articles of very large size are coated (e.g. buildings, vehicles, etc.), the curing is preferably carried out under ambient conditions.

Preferably, the curing time for step (b) is from 0.01 to 24 h, more preferably from 0.10 to 16 h, still more preferably from 0.15 to 8 h, and most preferably from 0.20 to 5 h, depending on the coating composition and coating thickness.

After curing in step (b), the silazane-containing polymer and the fluorine-containing polymer are chemically linked to form a coating on the surface of the article.

The coating obtained by the above method forms a rigid and dense functional coating which is excellent in adhesion to the surface and imparts at least one of the following improved properties to the article: improved mechanical resistance and durability (including improved surface hardness, improved scratch resistance and/or improved abrasion resistance); improved wetting and adhesion properties (including hydro- and oleophobicity, easy-to-clean effect and/or anti-graffiti effect); improved chemical resistance (including improved corrosion resistance (e.g. against solvents, acidic and alkaline media and corrosive gases) and/or improved anti-oxidation effect); improved optical effects (improved light fastness); and improved physical barrier or sealing effects.

### Article

Moreover, a coated article is provided, which is obtainable or obtained by the above-mentioned preparation method.

### Use

The present invention further relates to the use of the coating composition according to the present invention for forming a functional coating on the surface of a base material.

It is preferred that by the use according to the present invention one or more of the following surface properties is improved: mechanical resistance and durability (including surface hardness, scratch resistance and/or abrasion resistance); wetting and adhesion properties (including hydro- and oleophobicity, easy-to-clean effect and/or anti-graffiti effect); chemical resistance (including corrosion resistance (e.g. against solvents, acidic and alkaline media and corrosive gases) and/or anti-oxidation effect); optical effects (light fastness); and physical barrier or sealing effects.

Preferred base materials, to which the coating composition according to the present invention is applied, include a wide variety of materials such as, for example, metals (such as iron, steel, silver, zinc, aluminum, nickel, titanium, vanadium, chromium, cobalt, copper, zirconium, niobium, molybdenum, ruthenium, rhodium, silicon, boron, tin, lead or manganese or alloys thereof provided, if necessary, with an oxide or plating film); plastics (such as polymethyl methacrylate (PMMA), polyurethane, polyesters (PET), polyallyldiglycol carbonate (PADC), polycarbonate, polyimide, polyamide, epoxy resin, ABS resin, polyvinyl chloride, polyethylene (PE), polypropylene (PP), polythiocyanate, or polytetrafluoroethylene (PTFE)); glass (such as fused quartz, soda-lime-silica glass (window glass), sodium borosilicate glass (Pyrex®), lead oxide glass (crystal glass), aluminosilicate glass, or germanium-oxide glass); and construction materials (such as brick, cement, ceramics, clay, concrete, gypsum, marble, mineral wool, mortar, stone, or wood and mixtures thereof).

The base materials may be treated with a primer to enhance the adhesion of the functional coating. Such primers are, for instance, silanes, siloxanes, or silazanes. If plastic materials are used, it may be advantageous to perform a pretreatment by flaming, corona or plasma treatment which might improve the adhesion of the functional coating. If construction materials are used, it may be advantageous to perform a precoating with lacquers, varnishes or paints such as, for example, polyurethane lacquers, acrylic lacquers and/or dispersion paints.

The present invention is further illustrated by the examples following hereinafter which shall in no way be construed as limiting. The skilled person will acknowledge that various modifications, additions and alternations may be made to the invention without departing from the spirit and scope of the present invention.

### EXAMPLES

### Example 1

### Standard Operation Procedure

In the inventive examples, free hydroxyl groups of Lumiflon LF200F (available from AGC Chemicals Europe Ltd, Netherlands) having an hydroxyl number of 49 were reacted with 3-isocyanatopropyl-triethoxysilane (available from Sigma-Aldrich Chemie GmbH, Germany) to convert the “OH” functionality to a “Si(OEt)₃” functionality. The modified fluoropolymer was then mixed with Durazane 1500 rapid cure (available from MERCK KGaA, Germany) and applied on steel-panels (available from Q-Lab Corp., USA) by dip-coating. After curing at two conditions (ambient for 3 days and 1 h at 150° C. in oven), a salt spray test was made (to check the corrosion protection effect), a crosscut test was made (to check the adhesion) and a pencil hardness test was made (to check the scratch resistance).

### Functionalization of Lumiflon

100 g of solid Lumiflon were dissolved in 250 g water free xylene by stirring at room temperature for 24 h. After a clear solution was obtained, 21.6 g 3-isocyanatopropyl-triethoxayilane were added and the reaction mixture was heated to 80° C. for 8 h. The complete reaction of all isocyanate groups was confirmed by FT-IR measurement by absence of the NCO signal at 2270 cm−1.

### Preparation of Formulation

100 g of the solution of triethoxysilane modified Lumiflon in xylene was mixed with 27 g Durazane 1500 rapid cure. A clear colorless solution of medium viscosity was obtained.

### Preparing of Coated Steel Panels by Dip Coating

For each entry No. 1 to No. 4 in Table 1 below four steel panels were prepared. Two panels were cured in an oven at 150° C. for 1 h and two panels were cured at ambient conditions for 3 days.

Panel No. 1: Formulation: Lumiflon at 29% solid dissolved in xylene

Dip-Coating speed: 0.5 m/s.

Drying at ambient conditions for 1 day

Dip-Coating speed: 0.5 m/s.

Film thickness after drying/curing: 40-50 μm

Panel No. 2: Formulation: Durazane 1500 rapid cure

Dip-Coating speed: 0.5 m/s

Drying at ambient conditions for 1 day

Dip-Coating speed: 0.5 m/s.

Film thickness after drying: 40-50 μm=>crack formation after drying

Panel No. 3: Formulation: Durazane 1500 rapid cure

Dip-Coating speed: 1.0 m/s.

Film thickness after drying: 8-12 μm

Panel No. 4: Formulation: Formulation of Example 1

Dip-Coating speed: 0.5 m/s.

Drying at ambient conditions for 1 day

Dip-Coating speed: 0.5 m/s.

Film thickness after drying: 40-50 μm

One panel of each formulation (except No. 2 due to crack formation) cured at ambient conditions was submitted to a neutral salt spray test for 1000 h. The other panels of each formulation-curing combination (except No. 2 due to crack formation) were used to perform the pencil hardness test and the crosscut test. See Table 1 below for results.

TABLE 1
Test results

| | Material/ | NSS | | Pencil |
|---|---|---|---|---|
| Panel | film thickness | Test* | Crosscut** | Hardness*** |
| No. 1 | Pure Lumiflon/ | 0/0-0 | 0/0 | 2 B/1 H |
| | 40-50 μm | | | |
| No. 2 | Pure Durazane | —**** | —**** | —**** |
| | 1500 rc/40-50 μm | | | |
| No. 3 | Pure Durazane | 1/1-1 | 0/0 | 9 H/7-8 H |
| | 1500 rc/8-12 μm | | | |
| No. 4 | Example 1/ | 0/0-0 | 0/0 | 9 H/7-8 H |
| | 40-50 μm | | | |

*NSS = Neutral Salt Spray Test according to DIN EN ISO 9227 for 1000 h on bare steel panels, curing 3 d @ ambient conditions. Evaluation rating: A) Corrosion creep: <0.5 mm corresponds to “0”; 0.5-2 mm corresponds to “1”; and >2 mm corresponds to “2”;/B) Rust spots, size-amount: <1 mm² and <10 m⁻² corresponds to “0-0”; <2 mm² and <25 m⁻² corresponds to “1-1”; >2 mm² and >25 m⁻² corresponds to “2-2”.
**Crosscut Test according to DIN EN ISO 2409. Ranking from 0 to 5: 0 = perfect adhesion and 5 = complete delamination. Curing: 3 d @ ambient conditions/1 h @ 150° C.
***Pencil Hardness Test according to DIN EN ISO 15184. Pencil type: “Austria Cretacolor 150”. Curing: 3 d @ ambient conditions/1 h @ 150° C.
****failed: crack formation at film thickness >20 μm.

Advantage of Example 1 compared to pure Lumiflon: strongly improved scratch resistance at 150° C. cure and very strongly improved scratch resistance at ambient condition cure.

Advantage of Example 1 compared to pure 1500 rc: higher film thickness possible and increased corrosion protection.

### Example 2

### Standard Operation Procedure (SOP)

In other inventive examples, the free hydroxyl groups of Lumiflon LF200F (available from AGC Chemicals Europe Ltd, Netherlands) having a hydroxyl number of 49 were not chemically protected.

A solution of the fluoropolymer in xylene was directly mixed by simple stirring for 10 min with a solution of OPSZ (OPSZ=Durazane 1800, available from MERCK KGaA, Germany) in xylene and optionally with other additives. Since there is a slow reaction of the OH groups of the fluoropolymer with OPSZ, there is a limited pot-life of about 8 to 12 h during which the formulation should be applied. This formulation is regarded as a two-component system. Component No. 1 is the fluoropolymer/xylene solution and Component No. 2 is the OPSZ. The optional additives can be added to both components.

The formulation was applied on aluminum panels (available from Q-Lab Corp., USA) by dip-coating, on 4 inch silicon wafers (available from Microchemicals Germany) by spin coating, on silicon wafers having a silver surface (available from Microchemicals, Germany) by spin coating and on a copper film (available from VWR, Germany) by dip coating. All substrates were cured at 150° C. for 4 h and tested as shown below.

### Preparation of Substrate 1

Substrate 1 (see Table 2) was prepared according to the SOP as described above.

TABLE 2
Preparation of Substrate 1

| | | | Ratio | | | |
|---|---|---|---|---|---|---|
| | | | Comp. | | | |
| | | Additive | 1:Comp. | | | Film |
| | | in | 2 | Coating | | thickness |
| Comp. 1 | Comp. 2 | Comp. 2 | [g:g] | method | Substrate | [μm] |
| 40 g | 40 g | — | 2:1 | dip | aluminum | 25-30 |
| Lumiflon + | OPSZ + | | | | panel | |
| 60 g | 60 g | | | | | |
| Xylene | xylene | | | | | |

### Test of Substrate 1

A 0.5 ml drop of 5% aqueous NaOH was placed on the coating and kept there for 16 h at ambient conditions. Then, the precipitated solid NaOH (the water was evaporated during the 16 h) was washed away with water. The surface was visually inspected, if any spot could be detected (see Table 3).

TABLE 3
Test of Substrate 1

| Substrate | Visual inspection on spot | Pencil hardness |
|---|---|---|
| Substrate 1 | No spot | >9 H |
| Reference 1* | Heavy black spot | — (no coating) |
| Reference 2** | No spot | 1-2 H |
| Reference 3*** | Small slightly yellow spot | >9 H |

*Reference 1 = bare aluminum panel.
**Reference 2 = only Component 1 (pure Lumiflon), dip coating, aluminum panel, 25-30 μm.
***Reference 3 = only Component 2 (pure Durazane), dip coating, aluminum panel, 25-30 μm.

This example demonstrates the performance of the inventive coating composition to form a hard coating on aluminum which perfectly protects the aluminum from attack by strong alkaline media. Protection of aluminum and other metals against alkaline solutions is, for example, important in the automotive area, where strong alkaline detergents are used for the cleaning of vehicles.

### Preparation of Substrates 2-A to 2-C

Substrates 2-A to 2-C (see Table 4) were prepared according to the SOP as described above.

TABLE 4
Preparation of Substrates 2-A to 2-C

| | | | | Ratio | | | |
|---|---|---|---|---|---|---|---|
| | | | Additive | Comp. 1:Comp. | | | Film |
| | | | in | 2 | Coating | | thickness |
| Substrate | Comp. 1 | Comp. 2 | Comp. 2 | [g:g] | method | Substrate | [μm] |
| Substrate | 40 g | 40 g | — | 2:1 | spin | silicon | 6 |
| 2-A | Lumiflon + | OPSZ* + | | | | wafer | |
| | 60 g | 60 g | | | | | |
| | xylene | Xylene | | | | | |
| Substrate | 40 g | 39.5 g | 0.5 g | 2:1 | spin | silicon | 6 |
| 2-B | Lumiflon + | OPSZ* + | Tego | | | wafer | |
| | 60 g | 60 g | Phobe | | | | |
| | xylene | Xylene | 1505** | | | | |
| Substrate | 40 g | 39 g | 1 g | 2:1 | spin | silicon | 6 |
| 2-C | Lumiflon + | OPSZ* + | Surflon | | | wafer | |
| | 60 g | 60 g | S-651 | | | | |
| | xylene | xylene | *** | | | | |

*OPSZ = Durazane 1800 (available from MERCK KGaA, Germany).
**Tego Phobe 1505: available from Evonik Germany.
*** Surflon S-651: available from Seimi Chemical Japan.

### Test of Substrates 2-A to 2-C

After coating and curing, the contact angle of water and mineral oil was measured using a Krüss Mobile Surface Analyzer (see Table 5).

TABLE 5
Test of Substrates 2-A to 2-C and References 1 and 2

| | Contact angle | Contact angle |
|---|---|---|
| | water | mineral oil |
| Substrate | [°] | [°]*** |
| 2A | 102 | 70 |
| 2B | 112 | 67 |
| 2C | 101 | 81 |
| Reference 1* | 95 | 65 |
| Reference 2** | 103 | 69 |

*Reference 1 = only Component 1 (pure Lumiflon), spin coating, silicon wafer, 6 μm.
**Reference 2 = only Component 2 without additive (pure Durazane) spin coating, silicon wafer, 6 μm.
***mineral oil = white mineral oil available from Sigma Aldrich, γ ~30, 7 · 10⁻³ N/m.

These examples demonstrate the possibility of further enhancing the performance of the coating composition (as shown here on the example of hydro- and oleophobicity) by the addition of functional additives.

### Preparation of Substrate 3

Substrate 3 (see Table 6) was prepared according to the SOP as described above.

TABLE 6
Preparation of Substrate 3

| | | | Ratio | | | |
|---|---|---|---|---|---|---|
| | | Additive | Comp. 1:Comp. | | | Film |
| | | in | 2 | Coating | | thickness |
| Comp. 1 | Comp. 2 | Comp. 2 | [g:g] | method | Substrate | [μm] |
| 40 g | 40 g | — | 2:1 | spin | Si-wafer | 5-6 |
| Lumiflon + | OPSZ* + | | | | with Ag | |
| 60 g | 60 g | | | | mirror | |
| xylene | xylene | | | | | |

*OPSZ = Durazane 1800 (available from MERCK KGaA, Germany).

### Test of Substrate 3

After coating and curing, the silver sputtered silicon wafers were placed in a closed glass desiccator for 48 h containing a glass dish with 5 g of solid sodium sulfite and 20 ml of 5% aqueous acetic acid. Then, the corrosion (discoloration or attack of the surface) was visually investigated (see Table 7).

TABLE 7
Test of Substrate 3

| | Visual inspection on |
|---|---|
| Substrate | corrosion |
| Substrate 3 | No corrosion, surface |
| | unchanged |
| Reference 1* | Heavy corrosion, black |
| | surface |

*Reference 1 = bare Ag-sputtered Si-wafer.

### Preparation of Substrate 4

Substrate 4 (see Table 8) was prepared according to the SOP as described above.

TABLE 8
Preparation of Substrate 4

| | | | Ratio | | | |
|---|---|---|---|---|---|---|
| | | Additive | Comp. 1:Comp. | | | Film |
| | | in | 2 | Coating | | thickness |
| Comp. 1 | Comp. 2 | Comp. 2 | [g:g] | method | Substrate | [μm] |
| 40 g | 40 g | — | 2:1 | dip | 40 μm | 12-15 |
| Lumiflon + | OPSZ* + | | | | copper | |
| 60 g | 60 g | | | | film | |
| xylene | xylene | | | | | |

*OPSZ = Durazane 1800 (available from MERCK KGaA, Germany).

### Test of Substrate 4

After coating and curing, the copper film was placed in a closed glass desiccator for 48 h containing a glass dish with 5 g of solid sodium sulfite and 20 ml of 5% aqueous acetic acid. Then, the corrosion (discoloration or attack of the surface) was visually investigated (see Table 9).

TABLE 9
Test of Substrate 4

| | Visual inspection on |
|---|---|
| Substrate | corrosion |
| 4 | No corrosion, surface |
| | unchanged |
| Reference 1* | Heavy corrosion, dark |
| | surface |

*Reference 1 = bare copper film.

The testing of Substrates 3 and 4 demonstrates the use of the inventive formulation to protect sensitive surfaces from corrosion by aggressive environments. There is a broad need for transparent anti-corrosion coatings. Examples are the silver mirror background in LED packages or IC devices which have to be operated under harsh conditions, as for example sensors in the automotive industry.

1. A coating composition, comprising:
(i) a silazane-containing polymer; and
(ii) a fluorine-containing polymer comprising a first repeating unit U¹ and a second repeating unit U²;
wherein the first repeating unit U¹ is a fluorine-containing ethylene repeating unit and the second repeating unit U² is a fluorine-free vinyl ether repeating unit.

2. The coating composition according to claim 1, wherein the second repeating unit U² is represented by formula (B): 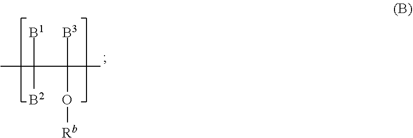
wherein B¹, B² and B³ are the same or different from each other and independently are H, alkyl having 1 to 30 carbon atoms or aryl having 2 to 30 carbon atoms; and
R^{b} is an organic group, a heteroorganic group, or a combination thereof.

3. The composition according to claim 1, wherein the first repeating unit U¹ is represented by formula (A): 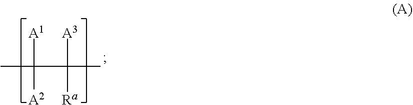
wherein A¹, A² and A³ are the same or different from each other and independently are F, perfluorinated alkyl having 1 to 30 carbon atoms or prefluorinated aryl having 2 to 30 carbon atoms; and
R^{a} is F, Cl, Br or alkyl having 1 to 30 carbon atoms or aryl having 2 to 30 carbon atoms, wherein one or more hydrogen atoms may be replaced by F.

4. The coating composition according to claim 1, wherein the fluorine-containing polymer further comprises a third repeating unit U³, wherein the third repeating unit U³ is represented by formula (C): 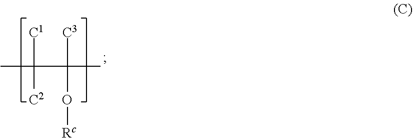
wherein C¹, C² and C³ are the same or different from each other and independently are hydrogen, alkyl having 1 to 30 carbon atoms or aryl having 2 to 30 carbon atoms; and
R^{c} is hydrogen, an organic group, a heteroorganic group or a combination thereof, which comprises one or more functional groups, independently from each other selected from the group consisting of —OH and —Si(OR^{II})₃; wherein R^{II} is at each occurrence independently of each other alkyl having 1 to 10 carbon atoms.

5. The coating composition according to claim 4, wherein R^{c} is hydrogen, alkyl having 1 to 30 carbon atoms, alkylaryl or alkylarylsulfonyl having 3 to 30 carbon atoms, arylalkyl or arylalkylsulfonyl having 3 to 30 carbon atoms, or alkylarylalkyl or alkylarylalkylsulfonyl having 4 to 30 carbon atoms,
wherein one or more non-terminal and non-adjacent CH₂ groups may be replaced, independently of each other, by —O—, —(C═O)—, —(C═O)O—, —O(C═O)—, —(C═O)—NR^{I}—, —NR^{I}—(C═O)—, —NR^{I}—(C═O)O—, —O(C═O)—NR^{I}—, —NR^{I}—(C═O)—NR^{I}—, —SO₂—, —C₆H₄— (phenylene), —C₁₀H₆— (naphthylene), —CH═CH— or —C≡C—, and which comprises one or more functional groups, independently of each other selected from the group consisting of —OH and —Si(OR^{II})₃;
wherein R^{I} is hydrogen or alkyl having 1 to 10 carbon atoms; and R^{II} is at each occurrence independently of each other alkyl having 1 to 10 carbon atoms.

6. The composition according to claim 1, wherein the molar amount of the first repeating unit U¹ in the fluorine-containing polymer is 5 to 96% based on the total molar amount of repeating units in the fluorine-containing polymer.

7. The coating composition according to claim 1, wherein the silazane-containing polymer comprises a repeating unit M¹ represented by formula (1):
—[SiR¹R²—NR³—] (I)
wherein R¹, R² and R³ are the same or different from each other and independently are hydrogen, an organic group, a heteroorganic group, or a combination thereof.

8. The coating composition according to claim 7, wherein the silazane-containing polymer further comprises a repeating unit M² represented by formula (II):
—[SiR⁴R⁵—NR⁶—] (II)
wherein R⁴, R⁵ and R⁶ are the same or different from each other and independently are hydrogen, an organic group, a heteroorganic group, or a combination thereof.

9. The coating composition according to claim 7, wherein the silazane-containing polymer further comprises a repeating unit M³ represented by formula (III):
—[SiR⁷R⁸—O—] (III)
wherein R⁷ and R⁸ are the same or different from each other and independently are hydrogen, an organic group, a heteroorganic group, or a combination thereof.

10. The coating composition according to claim 1, wherein the composition further comprises one or more solvents.

11. The coating composition according to claim 1, wherein the composition further comprises one or more additives.

12. The coating composition according to claim 1, wherein the mass ratio between the silazane-containing polymer and the fluorine-containing polymer is 1:100 to 100:1.

13. A method for preparing a coated article, comprising
(a) applying the coating composition according to claim 1 to a surface of an article; and
(b) curing said coating composition to obtain a coated article.

14. The method according to claim 13, wherein the coating composition applied in step (a) is previously provided by mixing a first component comprising a silazane-containing polymer with a second component comprising a fluorine-containing polymer, wherein the silazane-containing polymer and the fluorine-containing polymer are according to claim 1.

15. A coated article, obtainable by the method according to claim 13.

16. A method for forming a functional coating on the surface of a base material, comprising applying the coating composition according to claim 1 to the surface of said base material.

17. The coating composition according to claim 1, wherein the molar amount of the first repeating unit U¹ in the fluorine-containing polymer is 10 to 91% based on the total molar amount of repeating units in the fluorine-containing polymer.

18. The coating composition according to claim 1, wherein the mass ratio between the silazane-containing polymer and the fluorine-containing polymer is 1:10 to 10:1.
